(19) United States
(12) Patent Application Publication
(10) Pub. No.: US 2023/0359728 A1
(43) Pub. Date: Nov. 9, 2023

(54) DATA SECUREMENT LEVERAGING SECURE QR CODE SCANNER

(71) Applicant: Bank of America Corporation, Charlotte, NC (US)

(72) Inventors: Napangsiri Wanpen, New York, NY (US); Trish Gillis, Chicago, IL (US); Jennifer Sanctis, Charlotte, NC (US); Taylor Farris, Hoboken, NJ (US)

(21) Appl. No.: 17/737,253

(22) Filed: May 5, 2022

(51) Int. Cl. G06Q 20/32; G06F 21/54

(52) U.S. Cl. CPC G06F 21/54; G06Q 20/3276; G06F 2221/033

(57) ABSTRACT

A method for increasing a security of sensitive customer data when scanning a quick-response (“QR”) code is provided. The method may include, in response to authorizing login credentials of a user of a digital secure client-access application, deactivating an identified QR code scanner running on the mobile device and further activating a QR code secure scanner. The method may include verifying a first QR code scanned by the QR code secure scanner and in response to the verifying, releasing QR code data embedded in the first QR code, receiving approval from the first user of a transaction included in the QR code data and in response to the approval, generating a second QR code. The method may further include transmitting the second QR code to a second user and in response to an approval of the transaction by the second user, initiating the transaction.

### FIELD OF TECHNOLOGY

Aspects of the disclosure relate to quick response (“QR”) codes. Specifically, aspects of the disclosure relate to securing data when scanning QR codes.

### BACKGROUND OF THE DISCLOSURE

Quick response (“QR”) codes are used for many different purposes. QR codes may be found on advertisements, billboards and digital ads displayed on digital devices. QR codes may be found on tags of purchase items. QR codes may also be found within articles and other documents to enable retrieval of additional data.

QR codes may assist in a quicker payment process when purchasing an item. Additionally, QR codes enable providing additional data regarding the purchase item.

Online documents and paper documents may include QR codes that when scanned enable an individual to view additional data and information related to the document.

QR codes may also be found on invoices that may enable a quicker completion of a payment and/or to perform additional transactions. When a user scans the QR code on an invoice, the QR code may enable linking to the user’s account and may complete a transfer and/or execute additional transactions.

Because of the nearly ubiquitous usage of QR codes, malicious activity involving QR codes has become prevalent. For example, hackers embed QR codes with malicious URLs. Additionally, hackers replace legitimate QR codes with compromised QR codes.

When a user scans a QR code that is malicious and/or is linked to a malicious URL, this may compromise the user’s sensitive data stored on the user’s mobile device. Additionally, this may compromise online applications associated with the user.

It would be desirable, therefore, to provide systems and methods to secure sensitive data against malicious QR codes and further execute secure QR code scanner applications for safely identifying secure and/or non-secure QR codes.

### SUMMARY OF THE DISCLOSURE

A method for increasing a security of sensitive customer data when scanning a quick-response (“QR”) code is provided. The method may include authorizing a user’s login to a digital secure client-access platform.

The authorizing may include verifying that the user is an authorized user of the digital secure client-access platform. The authorizing may include verifying a password inputted by the user.

In response to the verification of the password, the method may include verifying input of a one-time passcode (“OTP”). The OTP may be generated by the digital secure client-access platform. The OTP may be transmitted to the user via email, text or any other suitable method.

In response to the authorizing of the OTP, the method may include activating a QR code secure scanner. The QR code secure scanner may implement QR code malware filtering applications embedded within the digital secure client-access platform. The security of the QR code secure scanner may be derived from the digital secure client-access platform.

For example, QR code malware filtering applications associated with the digital secure client-access platform may be derived from heightened security features associated with the digital secure client-access platform.

Specifically, the QR code malware filtering applications may only be launched and applied to the QR code secure scanner when a user’s login credentials are fully authorized. This may enable the data stored in the digital secure client-access platform to be protected from malicious QR codes.

The method may further include identifying a QR code via the QR code secure scanner. The method may also include scanning the QR code by the QR code secure scanner. Following the scanning, the method may include verifying the QR code data embedded in the QR code. The verifying may include verifying a recipient of a transaction included in the QR code data and verifying a security of a uniform resource locator (“URL”) included in the QR code data.

In response to the verifying of the recipient and the verifying of the security of the URL, the method may include releasing the QR code data embedded in the QR code to the user as readable QR code data and initiating the transaction.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure.

FIG. 2 shows an illustrative diagram in accordance with principles of the disclosure.

FIG. 3 shows an illustrative diagram in accordance with principles of the disclosure.

FIG. 4 shows an illustrative flow chart in accordance with principles of the disclosure.

FIG. 5A shows an illustrative flow chart in accordance with principles of the disclosure.

FIG. 5B shows an illustrative flow chart in accordance with principles of the disclosure.

FIG. 6 shows an illustrative block diagram of apparatus in accordance with the invention.

FIG. 7 shows an illustrative apparatus that may be configured in accordance with the invention.

### DETAILED DESCRIPTION OF THE DISCLOSURE

A system for increasing a security of sensitive customer data when scanning a quick-response (“QR”) code is provided. The system may be implemented within a secure digital client access platform.

A secure digital client access platform may be a digitally secure online platform for handling and managing private customer data. Specifically, the digitally secure platform may manage private customer sensitive data.

The digital secure client access platform may include a secure database for storing the sensitive customer data.

The system may include a camera embedded within a mobile device. The mobile device may be one or more of a laptop, smartphone, iPhone, tablet or any other suitable digital device.

The system may also include a default QR code scanner running on the mobile device. The default QR code scanner may be a built-in QR scanner that is embedded within the mobile device’s camera. The default QR code scanner may be a QR scanner application downloaded from a third-party source.

The system may also include a QR code secure scanner. The QR code secure scanner may reside within the secure digital client-access platform. The QR code secure scanner may be linked to the camera and activated in response to authorization of a first user’s login credentials to the secure digital client-access platform.

The QR code secure scanner may include a QR code reader embedded in the camera and a QR code secure analyzer for analyzing the QR code data for authenticity and security.

When the first user logs into the secure digital client access platform and the first user’s login credentials are authorized, a first processor running on the mobile device may be configured to identify a default scanner running on the mobile device.

In response to the identifying, the first processor may be configured to temporarily deactivate the default QR code scanner running on the mobile device.

In response to the deactivating, the first processor may be configured to activate the QR code secure scanner. By deactivating the default QR code scanner, the system may bypass the default QR code scanner when transmitting the QR code and/or QR code data to the QR code secure scanner.

It should be appreciated that a security of the QR code secure scanner may be derived from the secure digital client-access platform.

When the QR code secure scanner scans a first QR code, the QR code secure scanner is configured to verify a security level of QR code data embedded in the first QR code.

The verifying of the security level of the QR code data embedded in the first QR code may include verifying that any URLs embedded in the QR code are secure and not malicious. The verifying may include verifying that the QR code is from a safe-source and not fake.

The QR code secure scanner may implement QR code malware filtering applications embedded within the digital secure client-access platform. The security of the QR code secure scanner may be derived from heightened security features associated with the digital secure client-access platform.

Specifically, the QR code malware filtering applications may only be launched and applied to the QR code secure scanner when a user’s login credentials are fully authorized. This may enable the data stored in the digital secure client-access platform to be protected from malicious QR codes.

In some embodiments, the first QR code may not be verified. The transaction included in the QR code data may be fake. The URL may be linked to an insecure webpage.

When the first QR code is not verified, the QR code secure scanner may be configured to transmit an instruction to the processor of a failure to validate. In response to the instruction, the processor may be configured to display an alert message on a user interface (“UI”) of the mobile device. The processor may also disable any links embedded in the first QR code.

In some embodiments, when the first QR code is not verified, the QR code secure scanner may be configured to transmit an instruction to the processor of a failure to validate and in response to the instruction, the processor may be configured to terminate the generating of the second QR code.

In response to the verifying, the QR code secure scanner may be configured to release the QR code data embedded in the first QR code to the first user. The QR code data released may be released as readable QR code data.

The readable QR code data may be displayed to the first user on a UI on the first user’s mobile device. The readable QR code data may include data associated with an invoice that requires approval and confirmation to proceed with completing a transaction. The transaction may be payment of an invoice.

The QR code data embedded in the QR code may include a URL that, upon approval by the first user, may trigger an automatic linking to a webpage associated with the URL. The trigger may automatically link to the webpage by launching the webpage displayed on the UI.

The approval of the transaction may be via input by the first user. The input may be a finger swipe or touch on the approval button displayed on the UI. The input may be via voice recognition of the first user. The input may be via a hand or body gesture.

In response to a receipt of approval from the first user, the QR code secure scanner may be configured to generate a second QR code. The second QR code may include the QR code data embedded in the first QR code.

The first processor may be configured to transmit the second QR code to a second user’s mobile device. The second user may be a user of the secure digital client-access platform. The second user may be a pre-assigned approver linked to the first user.

The pre-assigned approver linked to the first user may be a user of the digital secure client-access platform. The pre-assigned approver may be selected by the first user and authorized by the first user to finalize approval of transactions within the digital secure client-access platform.

When the first user receives a QR code that is linked to an invoice or any other sort of transaction, a completion of the transaction may be executed upon authorization and approval of a first QR code, generating of a second QR code and approval of the second QR code. This may enable a two-layer authorization of the transaction and a two-layer approval of the transaction.

The second QR code may be received at the second user’s mobile device. A second processor running on the second user’s mobile device may be configured to instruct a display of the second user’s mobile device to display the QR code data embedded in the second QR code on a UI of the second user’s mobile device.

The second user may view the data. The second user may input an approval of the transaction included in the QR code data. The input may be via touch, voice and/or body motion.

In response to a combination of a receipt of the approval by the second user following verification of the first QR code by the QR code secure scanner and approval of the transaction by the first user, the second processor is configured to initiate the transaction.

In the event that the second QR code is not approved, the transaction may be terminated. In some embodiments, the first user may receive an alert message notifying the first user that the second QR code and the QR code data embedded in the second QR code is not approved by the second user.

In some embodiments, following the releasing of the QR code data, the first processor may determine that a URL is malicious. The first processor may determine that data associated with the transaction is fraudulent. When the first processor determines that the URL is malicious and/or the data associated with the transaction is false, the first processor may be configured to automatically log out the user from the digital secure client-access application. By logging out the user, the user’s sensitive data stored in the secure database within the digital secure client-access application may be protected.

A method for increasing a security of sensitive customer data when scanning a QR code is provided. The method may include logging into a digital secure client-access application on a user’s mobile device in response to authorization of the user’s login credentials. The user may be a first user.

In response to the logging, the method may include identifying any QR code scanners running on the mobile device. Mobile devices, i.e. - smartphones, may include one or more applications for scanning QR codes. The camera within the smartphone may capture the image/QR code and the application may read and process the image/QR code. Additionally, applications for scanning images and QR codes may be available for download from many online websites.

In response to the identifying of one or more QR code scanners running on the mobile device, the method may include temporarily deactivating each identified QR code scanner running on the mobile device.

In response to the deactivating, the method may include activating a QR code secure scanner. It should be appreciated that a security of the QR code secure scanner may be derived from the digital secure client-access application.

The activating of the QR code secure scanner may further include running a temporary electronic connection from the camera on the mobile device to the digital secure client-access application.

It should be appreciated that the running of the temporary electronic connection may further include, rerouting all QR codes to the QR code secure scanner for verification.

When the QR code secure scanner scans a first QR code, the method may include verifying QR code data embedded in the first QR code. The verifying may include verifying a recipient of a transaction included in the QR code data. The verifying of the recipient of the transaction may include verifying that the recipient is authentic and that the transaction associated with the recipient is accurate.

The verifying may be performed by comparing the identification of the recipient and the associated transaction with previous transactions associated with the recipient and stored in the digital secure client-access platform.

The verifying may also include verifying a security of a URL included in the QR code data. The verifying may include determining whether the URL and the webpages associated with the URL are secure and not associated with any malicious activity.

In response to the verifying of the recipient and the verifying of the security of the URL, the method may include releasing the QR code data embedded in the first QR code to the first user. The QR code data may be released and displayed to the user as readable QR code data. The readable QR code data may include details associated with an invoice and/or transaction. The readable QR code data may display the URL and data associated with the webpages linked to the URL.

The method may further include receiving approval from the first user of the transaction included in the readable QR code data.

In response to the approval, the method may include generating a second QR code via the QR code secure scanning device. The second QR code may include QR code data embedded in the first QR code.

The method may further include transmitting the second QR code to a mobile device associated with a second user. The second user may also be associated with the digital secure client-access application. The second user may be a pre-assigned approver linked to the first user.

The method may further include prompting the second user to approve the transaction.

The method include, in response to the prompt, receiving approval by the second user. The approval may be received via touch or swipe on the user’s mobile device. The approval may be received via voice input and/or body movement.

In response to receiving approval from the second user and in response to the verifying of the first QR code and the approval of the transaction by the first user, the method may include initiating the transaction.

It should be appreciated that in some embodiments, upon logging out of the digital secure client-access application on the first user’s mobile device, the method may include reactivating each deactivated identified QR scanner.

In the event that in response to the releasing of the QR code data a URL is determined to be malicious, the method may include automatically logging out the user from the digital secure client-access application thereby protecting the first user’s secure sensitive data stored in the digital secure client-access application.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

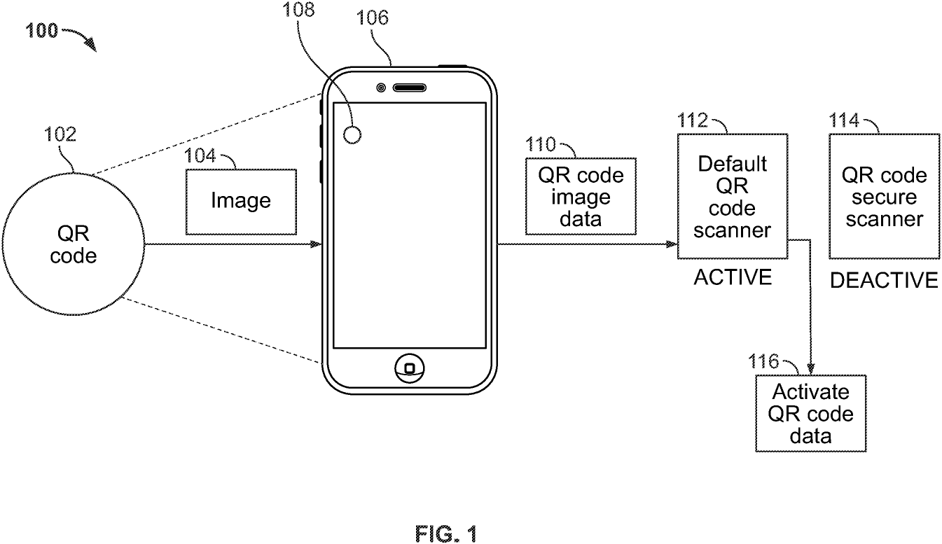

FIG. 1 shows an illustrative flow diagram 100 of a QR code 102 scanned and analyzed by a default QR code scanner 112. Default QR code scanner 112 may be running on a mobile device 106 in accordance with principles of the disclosure.

QR code 102 may be detected by camera 108 on user’s mobile device 106. QR code 102 may be displayed on a UI of another mobile device. QR code 102 may be embedded on an actual physical document.

Camera 108 may scan QR code 102 and the scanned image 104 may be stored on mobile device 106. The scanned image 104 and QR code image data 110 may be received by default QR code scanner 112. Default QR code scanner 112 may be the default QR code scanner running on mobile device 106.

QR code secure scanner 114 may be stored on mobile device 106. QR code secure scanner 114 may be deactivated when default QR code scanner 112 is in an active state.

Default QR code scanner 112 may be configured to, following the scanning and reading of the QR code data, activate the QR code 102, as shown at 116. The activating may include downloading of an application via a URL embedded in QR code 102. The activating may include launching a webpage via a URL embedded in QR code 102.

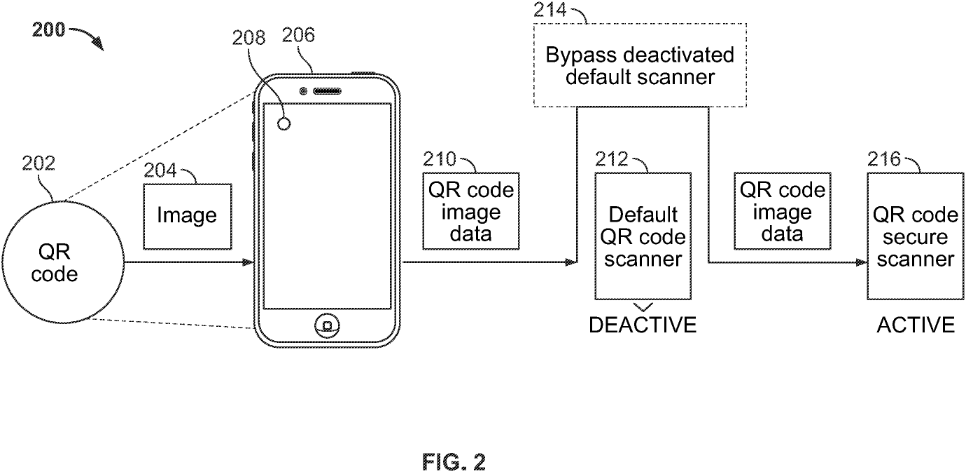

FIG. 2 shows illustrative flow diagram 200 of QR code 202 processed by QR code secure scanner 216 in accordance with principles of the disclosure.

A user of mobile device 206 may log onto the digital secure client-access platform via mobile device 206. Upon logging into the platform, default QR code scanner 212 may be automatically deactivated. Following deactivation of the default QR code scanner 212, QR code secure scanner 216 may be activated.

When a user of mobile device 206 is logged into the digital secure client-access platform, the user may scan a QR code such as QR code 202. The scanning may include a camera 208 of mobile device 206 capturing image 204 of QR code 202 and translating image 204 into QR code image data 210. QR code data may then bypass the deactivated default QR code scanner 212, as shown at 214, and be routed to QR code secure scanner 216.

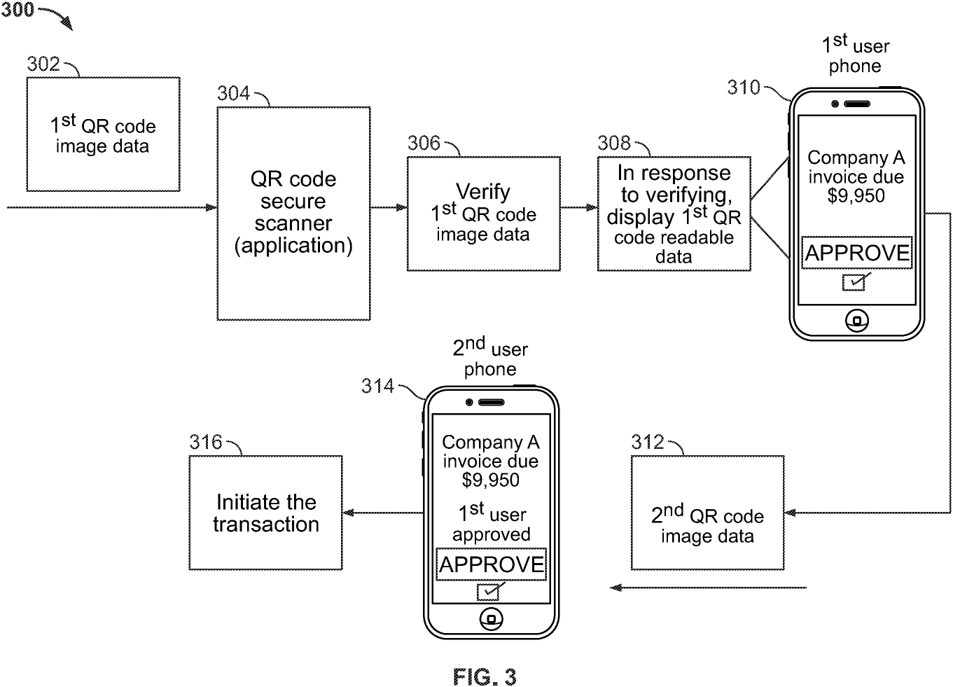

FIG. 3 shows an illustrative diagram 300 of QR code verification steps in accordance with principles of the disclosure.

First QR code image data 302 may be received by QR code secure scanner application 304. QR code secure scanner application 304 may verify first QR code image data, as shown at 306. The verification may include verifying a security of the data and the authenticity of the data.

At 308, in response to the verifying, QR code secure scanner application 304 may instruct mobile device to display first QR code readable data to a user of the mobile device.

At 310, the QR code readable data may be displayed on the UI. In this example, 310 may display data associated with ‘Company A’ invoice. The UI may display a selectable button for approval of the invoice included in the QR code data. Upon receipt of approval, second QR code 312 may be generated and the second QR code image data may be transmitted to a mobile device of a second user, as shown at 314.

Upon approval, mobile device 314 may transmit an instruction to initiate the transaction, as shown at 316.

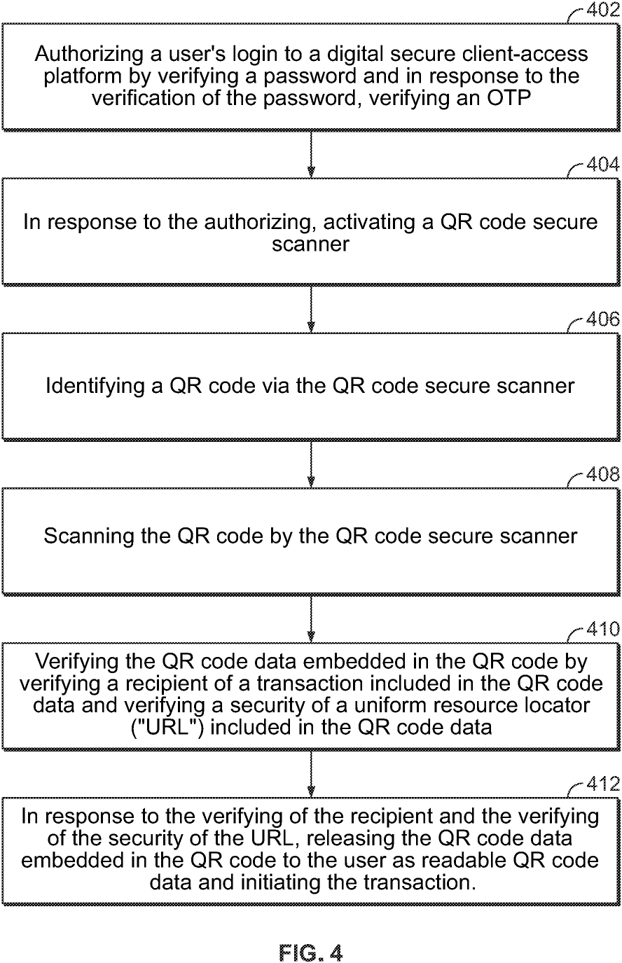

FIG. 4 shows illustrative method steps for increasing security of sensitive customer data when scanning QR codes.

At step 402, the method step may include authorizing a user’s login to a digital secure client-access platform. The authorizing may be performed by verifying a password inputted by the user and in response to the verification of the password, verifying an OTP generated by the digital secure client-access platform and inputted into the mobile device.

At step 404, in response to the authorizing, the method step may include activating a QR code secure scanner.

At step 406, the method step may include identifying a QR code via the QR code secure scanner. The QR code may be captured by the camera on the mobile device and received at the QR code secure scanner.

At step 408, the method step may include scanning the QR code by the QR code secure scanner. The scanning may include converting the captured image of the QR code into QR code image data.

At step 410, the method step may include verifying the QR code data, via the QR code secure scanner. The verifying may include verifying a recipient of a transaction included in the QR code data. The verifying may also include verifying a security of a URL included in the QR code data.

At step 412, the method step may include, in response to the verifying of the recipient and the verifying of the security of the URL, releasing the QR code data embedded in the QR code to the user as readable QR code data and further initiating the transaction.

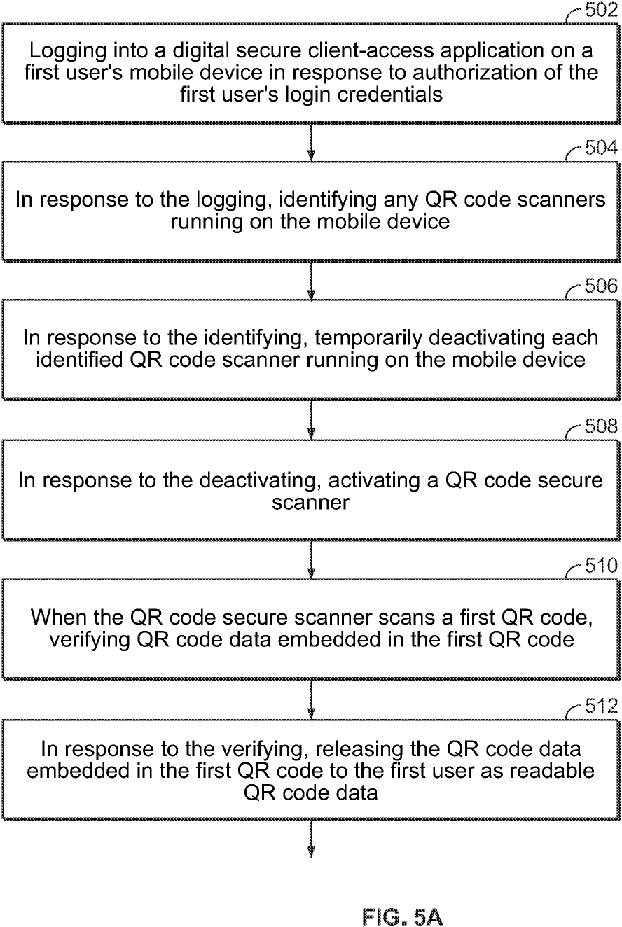

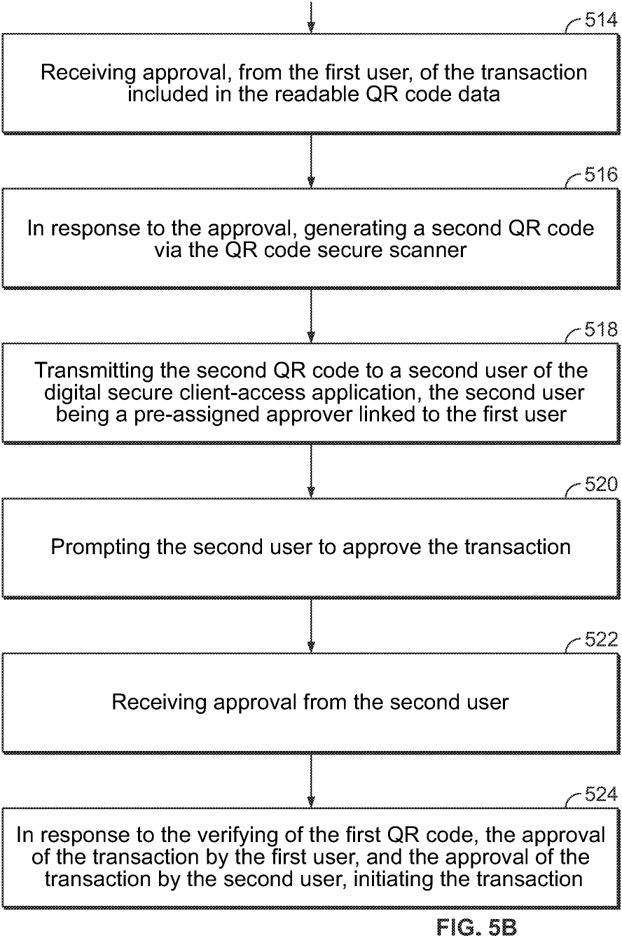

FIG. 5A shows illustrative method steps for increasing security of sensitive customer data when scanning QR codes.

At step 502, the method step may include logging into a digital secure client-access application on a first user’s mobile device. The logging in may be executed in response to authorization of the first user’s login credentials inputted into the digital secure client-access application.

At step 504, the method step may include, in response to the logging, identifying any QR code scanners running on the mobile device.

At step 506, in response to the identifying, the method step may include temporarily deactivating each identified QR code scanner running on the mobile device.

At step 508, in response to the deactivating, the method step may include activating a QR code secure scanner.

At step 510, when the QR code secure scanner scans a first QR code, the method step may include, verifying QR code data embedded in the first QR code.

At step 512, in response to the verifying, the method step my include, releasing the QR code data embedded in the first QR code to the first user as readable QR code data.

FIG. 5B shows a continuation of the illustrative flow chart described in FIG. 5A in accordance with principles of the disclosure.

At step 514, the method step may include receiving approval from the first user of the transaction included in the readable QR code data.

At step 516, in response to the approval, the method step may include generating a second QR code via the QR code secure scanner.

At step 518, the method step may include transmitting the second QR code to a second user of the digital secure client-access application. It should be appreciated that the second user may be a pre-assigned approver linked to the first user.

At step 520, the method step may include, prompting the second user to approve the transaction.

At step 522, the method step may include, receiving approval from the second user.

At step 524, in response to the verifying of the first QR code, the approval of the transaction by the first user and the approval of the transaction by the second user, the method step may include initiating the transaction.

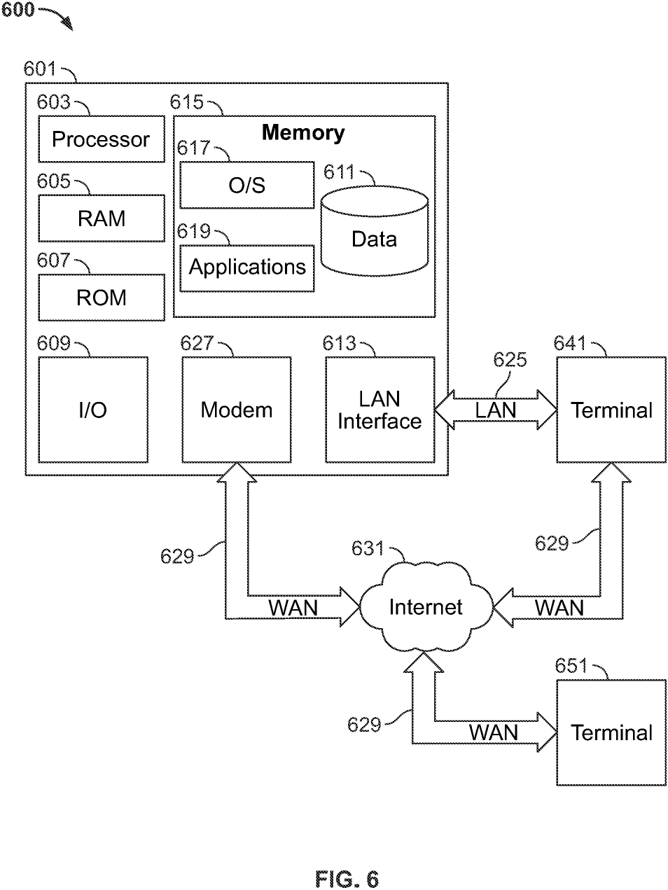

FIG. 6 shows an illustrative block diagram of system 600 that includes computer 601. Computer 601 may alternatively be referred to herein as an “engine,” “server” or a “computing device.” Computer 601 may be a workstation, desktop, laptop, tablet, smart phone, or any other suitable computing device. Elements of system 600, including computer 601, may be used to implement various aspects of the systems and methods disclosed herein. Each of the camera, default QR code scanner(s), QR code secure scanner, mobile device(s), first processor and second processor, may include some or all of the elements and apparatus of system 600. Furthermore, each of the method steps illustrated in FIGS. 34, 5A and 5B may be performed using one or more of the elements and apparatus of system 600.

Computer 601 may have a processor 603 for controlling the operation of the device and its associated components, and may include RAM 605, ROM 607, input/output circuit 609, and a non-transitory or non-volatile memory 615. Machine-readable memory may be configured to store information in machine-readable data structures. The processor 603 may also execute all software running on the computer-e.g., the operating system and/or voice recognition software. Other components commonly used for computers, such as EEPROM or Flash memory or any other suitable components, may also be part of the computer 601.

The memory 615 may be comprised of any suitable permanent storage technology-e.g., a hard drive. The memory 615 may store software including the operating system 617 and application(s) 619 along with any data 611 needed for the operation of computer 601. Memory 615 may also store videos, text, and/or audio assistance files. The data stored in Memory 615 may also be stored in cache memory, or any other suitable memory.

Input/output (“I/O”) module 609 may include connectivity to a microphone, keyboard, touch screen, mouse, and/or stylus through which input may be provided into computer 601. The input may include input relating to cursor movement. The input/output module may also include one or more speakers for providing audio output and a video display device for providing textual, audio, audiovisual, and/or graphical output. The input and output may be related to computer application functionality.

Computer 601 may be connected to other systems via a local area network (LAN) interface 613. Computer 601 may operate in a networked environment supporting connections to one or more remote computers, such as terminals 641 and 651. Terminals 641 and 651 may be personal computers or servers that include many or all of the elements described above relative to computer 601. When used in a LAN networking environment, computer 601 is connected to LAN 625 through a LAN interface 613 or an adapter. When used in a WAN networking environment, computer 601 may include a modem 627 or other means for establishing communications over WAN 629, such as Internet 631.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 619, which may be used by computer 601, may include computer executable instructions for invoking functionality related to communication, such as e-mail, Short Message Service (SMS), and voice input and speech recognition applications. Application program(s) 619 (which may be alternatively referred to herein as “plugins,” “applications,” or “apps”) may include computer executable instructions for invoking functionality related to performing various tasks. Application programs 619 may utilize one or more algorithms that process received executable instructions, perform power management routines or other suitable tasks. Application programs 619 may utilize one or more decisioning processes for determining when to reroute a transaction request from a first network to a second network.

Application program(s) 619 may include computer executable instructions (alternatively referred to as “programs”). The computer executable instructions may be embodied in hardware or firmware (not shown). The computer 601 may execute the instructions embodied by the application program(s) 619 to perform various functions.

Application program(s) 619 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 611, and any other suitable information, may be stored in memory 615. One or more of applications 619 may include one or more algorithms that may be used to implement features of the disclosure including the triggering for switching transaction requests from a first network to a second network.

The invention may be described in the context of computer-executable instructions, such as applications 619, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 601 and/or terminals 641 and 651 may also include various other components, such as a battery, speaker, and/or antennas (not shown). Components of computer system 601 may be linked by a system bus, wirelessly or by other suitable interconnections. Components of computer system 601 may be present on one or more circuit boards. In some embodiments, the components may be integrated into a single chip. The chip may be silicon-based.

Terminal 651 and/or terminal 641 may be portable devices such as a laptop, cell phone, Blackberry TM, tablet, smartphone, or any other computing system for receiving, storing, transmitting and/or displaying relevant information. Terminal 651 and/or terminal 641 may be one or more user devices. Terminals 651 and 641 may be identical to computer 401 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smart phones, multiprocessor systems, microprocessor-based systems, cloud-based systems, programmable consumer electronics, network PCs, minicomputers, mainframe computers, distributed computing environments that include any of the above systems or devices, and the like.

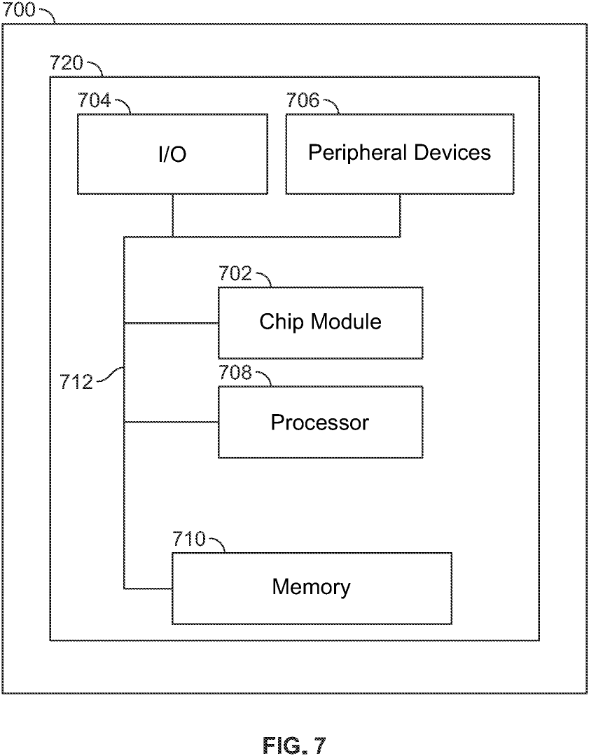

FIG. 7 shows illustrative apparatus 700 that may be configured in accordance with the principles of the disclosure. Apparatus 700 may be a computing device. Apparatus 700 may include one or more features of the apparatus shown in FIG. 1, FIG. 2 and FIG. 3. Apparatus 700 may include chip module 702, which may include one or more integrated circuits, and which may include logic configured to perform any other suitable logical operations.

Apparatus 700 may include one or more of the following components: I/O circuitry 704, which may include a transmitter device and a receiver device and may interface with fiber optic cable, coaxial cable, telephone lines, wireless devices, PHY layer hardware, a keypad/display control device or any other suitable media or devices; peripheral devices 706, which may include counter timers, real-time timers, power-on reset generators or any other suitable peripheral devices; logical processing device 708, which may compute data structural information and structural parameters of the data; and machine-readable memory 710.

Machine-readable memory 710 may be configured to store in machine-readable data structures: machine executable instructions, (which may be alternatively referred to herein as “computer instructions” or “computer code”), applications such as applications 719, signals, and/or any other suitable information or data structures.

Components 702, 704, 706, 708 and 710 may be coupled together by a system bus or other interconnections 712 and may be present on one or more circuit boards such as circuit board 720. In some embodiments, the components may be integrated into a single chip. The chip may be silicon-based.

Thus, systems and methods for increasing a security of sensitive customer data when scanning a QR code is provided. Persons skilled in the art will appreciate that the present invention can be practiced by other than the described embodiments, which are presented for purposes of illustration rather than of limitation.

What is claimed is:

1. A method for increasing a security of sensitive customer data when scanning a quick-response (“QR”) code, the method comprising:
logging into a digital secure client-access application on a user’s mobile device in response to authorization of login credentials associated with the user, the user being a first user;
in response to the logging, identifying any QR code scanners running on the mobile device;
in response to the identifying, temporarily deactivating each identified QR code scanner running on the mobile device;
in response to the deactivating, activating a QR code secure scanner, a security of the QR code secure scanner derived from the digital secure client-access application;
when the QR code secure scanner scans a first QR code, verifying QR code data embedded in the first QR code, the verifying comprising:
verifying a recipient of a transaction included in the QR code data; and
verifying a security of a uniform resource locator (“URL”) included in the QR code data;
in response to the verifying of the recipient and the verifying of the security of the URL, releasing the QR code data embedded in the first QR code to the first user as readable QR code data;
receiving approval from the first user of the transaction included in the readable QR code data;
in response to the approval, generating a second QR code via the QR code secure scanning device, the second QR code comprising QR code data embedded in the first QR code;
transmitting the second QR code to a second user of the digital secure client-access application, the second user being a pre-assigned approver linked to the first user;
prompting the second user to approve the transaction;
receiving approval from the second user; and
in response to the verifying of the first QR code, the approval of the transaction by the first user, and the approval of the transaction by the second user, initiating the transaction; and
wherein: upon logging out of the digital secure client-access application on the first user’s mobile device, reactivating each deactivated identified QR scanner.

2. The method of claim 1 wherein the activating of the QR code secure scanner comprises, running a temporary electronic connection from a camera on the mobile device to the digital secure client-access application.

3. The method of claim 2 wherein the running of the temporary electronic connection further comprises, rerouting all QR codes to the QR code secure scanner for verification.

4. The method of claim 1 wherein when the first QR code is not verified, the method comprises displaying an alert message on a user interface (“UI”) of the mobile device.

5. The method of claim 1 wherein when the first QR code is not verified, the method comprises disabling access to any one or more URL links included in the QR code data.

6. The method of claim 1 wherein when the first QR code is not verified, the method comprises terminating the generating of the second QR code.

7. The method of claim 1 wherein when in response to the releasing of the QR code data, a URL is determined to be malicious, the method comprises automatically logging out the user from the digital secure client-access application thereby protecting sensitive data of the first user stored in the digital secure client-access application.

8. A system for increasing a security of sensitive customer data when scanning a quick-response (“QR”) code, the system implemented within a secure digital client-access platform, the system comprising:
a camera embedded within a mobile device;
a default QR code scanner running on the mobile device;
a QR code secure scanner residing within the secure digital client-access platform, the QR code secure scanner linked to the camera and executed in response to authorization of a first user’s login credentials to the secure digital client-access platform;
wherein, when the first user logs into the secure digital client access platform and the first user’s login credentials are authorized, a first processor running on the mobile device is configured to:
identify the default QR code scanner running on the mobile device;
in response to the identifying, temporarily deactivate the default QR code scanner running on the mobile device; and
in response to the deactivating, activate the QR code secure scanner, a security of the QR code secure scanner derived from the secure digital client-access platform; and
when the QR code secure scanning device scans a first QR code, the QR code secure scanner is configured to verify a security level of QR code data embedded in the first QR code;
in response to the verifying, the QR code secure scanners configured to:
release the QR code data embedded in the first QR code to the first user as readable QR code data;
receive approval from the first user of a transaction included in the readable QR code data;
in response to the approval, generate a second QR code via the QR code secure scanner, the second QR code comprising QR code data embedded in the first QR code; and
transmit the second QR code to a second user of the secure digital client-access platform, the second user being a pre-assigned approver linked to the first user; and
a second processor running on a mobile device of the second user configured to:
receive a prompt inputted by the second user to approve the transaction;
receive input of an approval by the second user of the transaction included in the second QR code; and
in response to the verifying of the first QR code, the approval of the transaction by the first user, and the approval of the transaction by the second user, initiate the transaction.

9. The system of claim 8 wherein when the first QR code is not verified:
the QR code secure scanner is configured to transmit an instruction to the processor of a failure to validate; and
in response to the instruction, the processor is configured to display an alert message on a user interface (“UI”) of the mobile device.

10. The system of claim 8 wherein when the first QR code is not verified:
the QR code secure scanner is configured to transmit an instruction to the processor of a failure to validate; and
in response to the instruction, the processor is configured to disable access to a URL link included in the QR code data.

11. The system of claim 8 wherein when the first QR code is not verified:
the QR code secure scanner is configured to transmit an instruction to the processor of a failure to validate; and
in response to the instruction, the processor is configured to terminate the generating of the second QR code.

12. The system of claim 8 wherein the prompt inputted by the second user is one of a tap of a finger, swipe of the finger and a voice input.

13. The system of claim 8 wherein the digital secure client access platform includes a secure database storing sensitive data.

14. The system of claim 8 wherein when in response to the releasing of the QR code data, the processor determines that a URL is malicious, the processor is configured to automatically log out the user from the digital secure client-access platform thereby protecting the first user’s sensitive data stored in a secure database within the digital secure client-access platform.

15. A method for increasing a security of sensitive customer data when scanning a quick-response (“QR”) code, the method comprising:
authorizing a user’s login to a digital secure client-access platform, the authorizing comprising:
verifying a password; and
in response to the verification of the password, verifying a one-time password (“OTP”) generated by the digital secure client-access platform and inputted by the user;
in response to the authorizing, activating a QR code secure scanner, a security of the QR code secure scanner derived from the digital secure client-access platform;
identifying a QR code via the QR code secure scanner;
scanning the QR code by the QR code secure scanner;
verifying the QR code data embedded in the QR code, the verifying comprising:
verifying a recipient of a transaction included in the QR code data; and
verifying a security of a uniform resource locator (“URL”) included in the QR code data; and
in response to the verifying of the recipient and the verifying of the security of the URL:
releasing the QR code data embedded in the QR code to the user as readable QR code data; and
initiating the transaction.

16. The method of claim 15 wherein when the QR code is not verified, the method comprises displaying an alert message on a user interface (“UI”) of the first user’s mobile device.

17. The method of claim 15 wherein when the QR code is not verified, the method comprises disabling access to any one or more URL links included in the QR code data.

18. The method of claim 15 wherein when the QR code is not verified, the method comprises pausing the releasing of the QR code data to the user and terminating the initiating of the transaction.

19. The method of claim 15 wherein the activating of the QR code secure scanner comprises, running a temporary electronic connection from a camera on a mobile device of the user to the digital secure client-access platform.

20. The method of claim 19 wherein the running of the temporary electronic connection further comprises, rerouting all QR codes from a default QR code scanner to the QR code secure scanner for verification.
